(19) United States
(12) Patent Application Publication
(10) Pub. No.: US 2017/0004315 A1
(43) Pub. Date: Jan. 5, 2017

(54) METHOD AND SYSTEM FOR MAINTAINING DATA CONFIDENTIALITY, AND STORING AND TRANSMITTING THE DATA

(71) Applicants: J-Hong Lai, Taichung City (TW); J-Sheng Lai, Taichung City (TW)

(72) Inventors: J-Hong Lai, Taichung City (TW); J-Sheng Lai, Taichung City (TW)

(21) Appl. No.: 14/791,327

(22) Filed: Jul. 3, 2015

(51) Int. Cl. G06F 21/62; H04W 12/02; G06F 21/60

(52) U.S. Cl. CPC G06F 21/62; G06F 21/606; H04W 12/02

(57) ABSTRACT

In a system and a method for maintaining the confidentiality of data and storing and transmitting the data, the system includes one or more target devices connected to an online receiver module of a storage device through a connection module, and operated together with a password and a key to ensure the effect of protecting data while transmitting and storing the data.

### TECHNICAL FIELD

The technical field relates to confidential data storage and transmission methods and systems, in particular to a method and a system for maintaining the confidentiality of data, and storing and transmitting the confidential data.

### BACKGROUND

There is always a risk of leaking data while transmitting and storing the data by a device. Therefore, it is necessary to protect the confidentiality of the data when the data are transmitted and stored.

### SUMMARY

In view of the risk and problem of leaking data while transmitting and storing them by a device, it is an objective of this disclosure to provide a method and a system for maintaining the confidentiality of data and storing and transmitting the data to overcome the problem of the prior art.

To achieve the aforementioned objective, this disclosure provides a method and a system for maintaining the confidentiality of data, and storing and transmitting the data. The system comprises one or more target devices and at least one storage device. Wherein, the target device includes a computing module, an encryption/decryption module and a connection module, and the computing module is connected to the encryption/decryption module and the connection module, and the encryption/decryption module includes an encryption program unit and a decryption program unit, and the encryption program unit and decryption program unit are connected to the computing module, and the encryption program unit includes a first encryption unit and a second encryption unit, and the decryption program unit includes a key identification unit and a decryption unit, and the connection module is a cable or wireless connection device, and the storage device includes an online receiver module and a storage module, and the storage module includes a password group storage unit and an unlabeled key group storage unit, and the password group storage unit and unlabeled key group storage unit are connected to the online receiver module, and one or more target devices are connected to the online receiver module of the storage device through the connection module. The method for maintaining the confidentiality of data, and storing and transmitting the data comprises the steps of using a first encryption unit to form a key by encrypting a random value by an encryption program unit of an encryption/decryption module of a target device; using a second encryption unit to generate a password from data of the target device and the key; linking the key and the password with an online receiver module of a storage device by the connection module; storing the key into an unlabeled key group storage unit after the online receiver module has received the key and the password; storing the password into a password group storage unit; using a key identification unit for a key comparison by a decryption program unit of the encryption/decryption module of the target device; and eliminating all labeled keys to obtain unlabeled keys, and then using the decryption unit to compare with the password obtained by the storage device; such that if the comparison fails, then another key will be decrypted, and if the comparison succeeds, then the data and the key will be obtained, and the obtained key will be stored with label or without label.

### BRIEF DESCRIPTION OF THE DRAWINGS

FIG. 1 is a schematic view of an exemplary embodiment of a system and a method for maintaining the confidentiality of data, and storing and transmitting the data of this disclosure;

FIG. 2 is a schematic view of a target device in accordance with an exemplary embodiment of a system and a method for maintaining the confidentiality of data, and storing and transmitting the data of this disclosure;

FIG. 3 is a schematic view of a storage device in accordance with an exemplary embodiment of a system and a method for maintaining the confidentiality of data, and storing and transmitting the data of this disclosure;

FIG. 4 is a schematic view of an encryption process of a target device and a storage device in accordance with an exemplary embodiment of a system and a method for maintaining the confidentiality of data, and storing and transmitting the data of this disclosure;

FIG. 5 is a schematic view of an encryption process of a target device and a storage device in accordance with an exemplary embodiment of a system and a method for maintaining the confidentiality of data, and storing and transmitting the data of this disclosure;

FIG. 6 is a schematic view of a decryption process of a target device in accordance with an exemplary embodiment of a system and a method for maintaining the confidentiality of data, and storing and transmitting the data of this disclosure;

FIG. 7 is a schematic view of a storage process of a storage device key in accordance with an exemplary embodiment of a system and a method for maintaining the confidentiality of data, and storing and transmitting the data of this disclosure; and

FIG. 8 is a schematic view of a decryption process of a storage device and a target device in accordance with an exemplary embodiment of a system and a method for maintaining the confidentiality of data, and storing and transmitting the data of this disclosure.

### DESCRIPTION OF THE PREFERRED EMBODIMENTS

This disclosure will become clearer in light of the following detailed description of an illustrative embodiment described in connection with the drawings. It is intended that the embodiments and drawings disclosed herein are to be considered illustrative rather than restrictive.

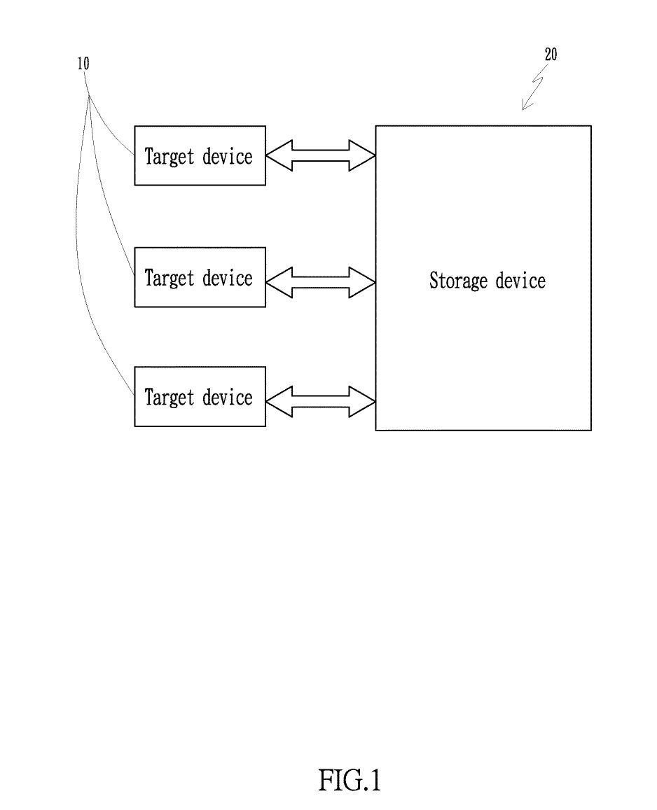

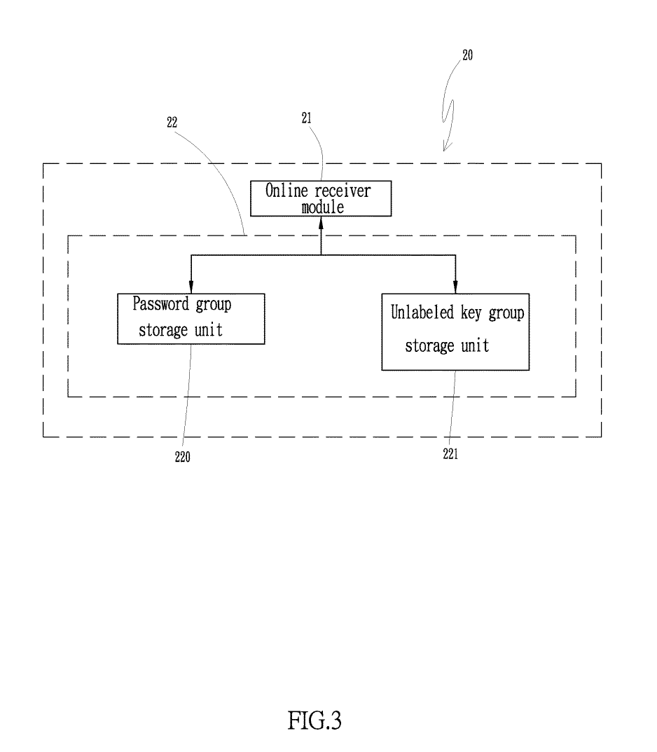

With reference to FIGS. 1 to 3 for the schematic views of an exemplary embodiment of a system, a target device, and a storage device of this disclosure respectively, the system comprises: one or more target devices 10, each including a computing module 11, an encryption/decryption module 12 and a connection module 13, and the computing module 11 being connected to the encryption/decryption module 12 and the connection module 13, and the encryption/decryption module 12 including an encryption program unit 120 and a decryption program unit 121, and the encryption program unit 120 and the decryption program unit 121 being connected to the computing module 11, and the encryption program unit 120 including a first encryption unit 120A and a second encryption unit 120B, and the decryption program unit 121 including a key identification unit 121A and a decryption unit 121B, and the connection module 13 being a cable or wireless connection device; and
a storage device 20, including an online receiver module 21 and a storage module 22, and the storage module 22 including a password group storage unit 220 and an unlabeled key group storage unit 221, and the password group storage unit 220 and the unlabeled key group storage unit 221 being connected to the online receiver module 21, and the storage device 20 being connected to the connection module 13 of at least one target device 10 through the online receiver module 21.

By the aforementioned components and modules, the system for maintaining the confidentiality of data and storing and transmitting the data is formed.

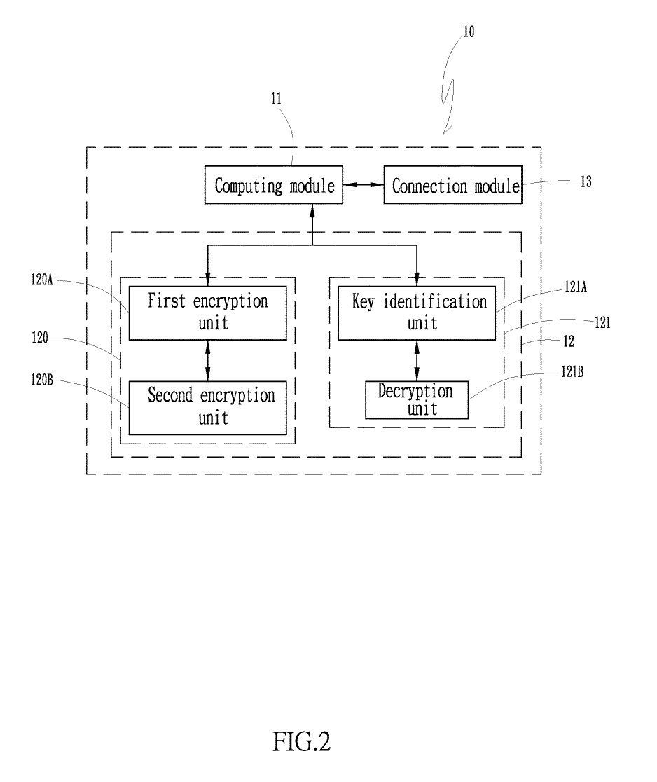

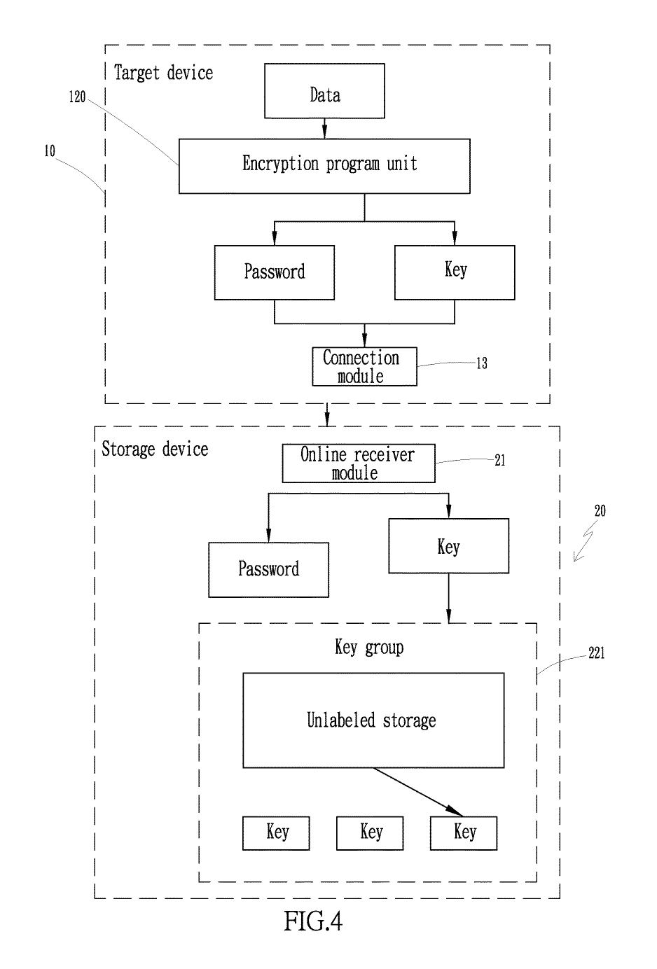

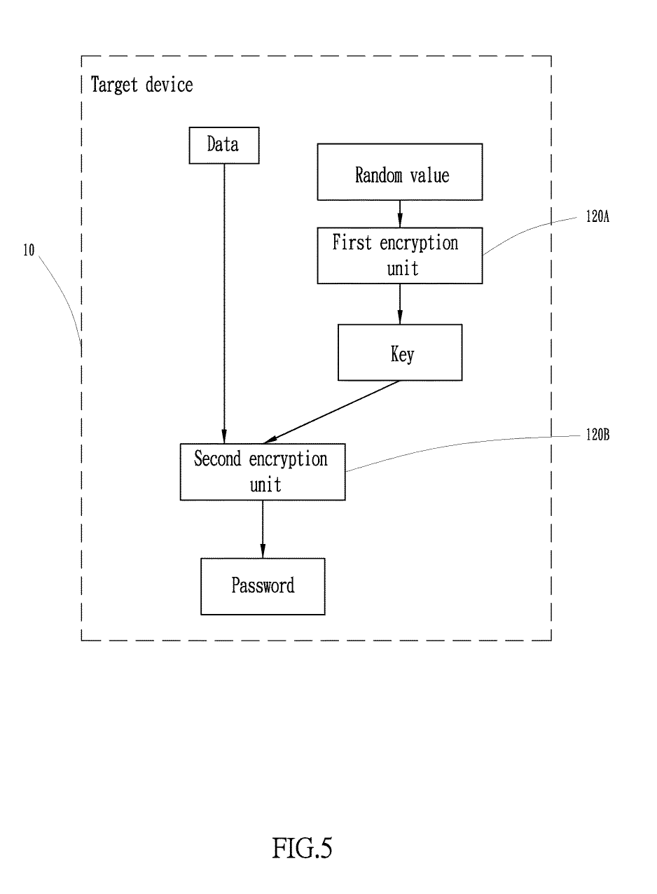

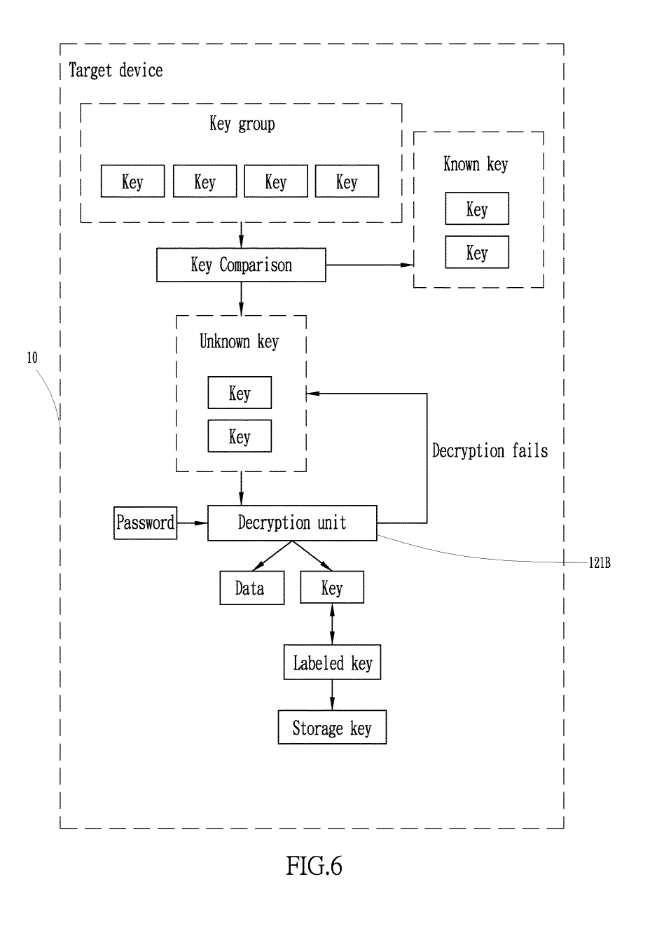

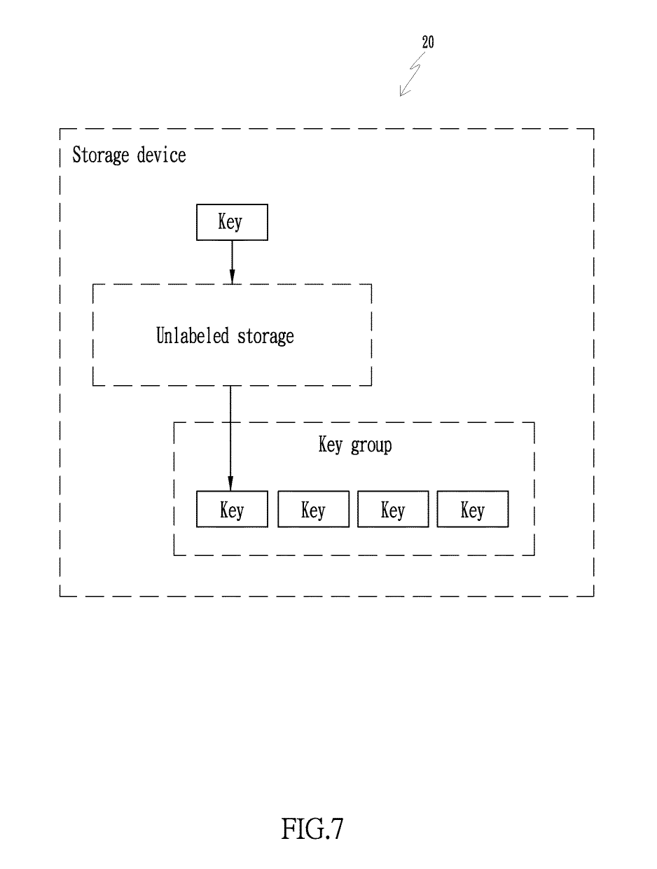

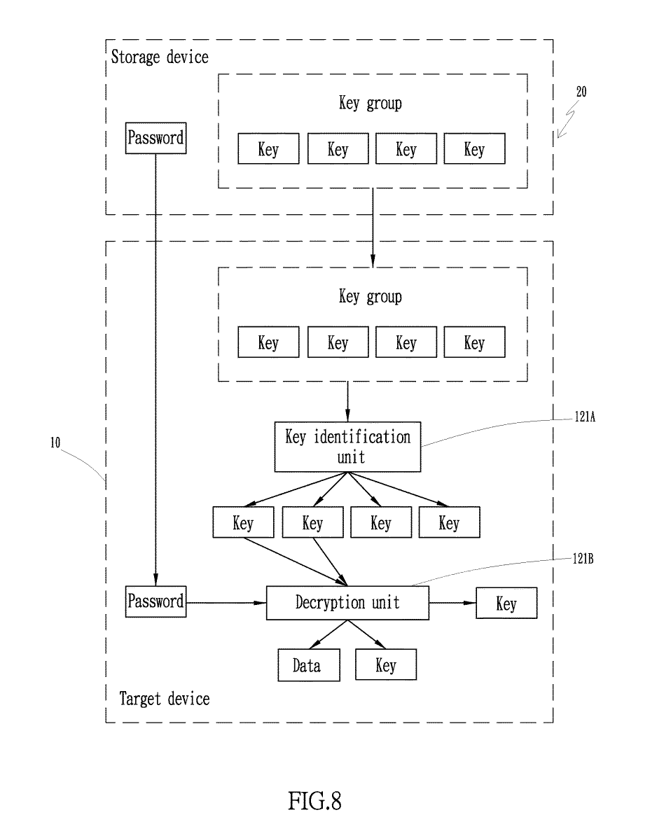

With reference to FIGS. 2 to 8 for the schematic views of an exemplary embodiment of a target device, a storage device, an encryption process of the target device and the storage device, an encryption process of the target device, a decryption process of the target device, a storage process of a storage device key and a decryption process of the storage device and the target device of the method for maintaining the confidentiality of data, and storing and transmitting the data respectively, the method comprises the steps of: using a first encryption unit to form a key by encrypting a random value (such as time, longitude, etc) by an encryption program unit 120 of the encryption/decryption module 12 of a target device; using a second encryption unit to generate a password target device 10 from data and the key; linking the key and password with the online receiver module 21 of the storage device 20 by the connection module 13; storing the key into an unlabeled key group storage unit 221 after the online receiver module 21 has received the key and the password; storing the password into a password group storage unit 220; using a key identification unit 121A for a key comparison by a decryption program unit 121 of the encryption/decryption module 12 of the target device; and eliminating all labeled keys to obtain unlabeled keys, and then using the decryption unit 121B to compare with the password obtained by the storage device 20; such that if the comparison fails, then another key will be decrypted, and if the comparison succeeds, then the data and the key will be obtained, and the obtained key will be stored with label or without label.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A system for maintaining the confidentiality of data and storing and transmitting the data, comprising:
one or more target devices, each including a computing module, an encryption/decryption module and a connection module, and the computing module being connected to the encryption/decryption module and the connection module, and the encryption/decryption module including an encryption program unit and a decryption program unit, and the encryption program unit and the decryption program unit being connected to the computing module, and the encryption program unit including a first encryption unit and a second encryption unit, and the decryption program unit including a key identification unit and a decryption unit; and
a storage device, including an online receiver module and a storage module, and the storage module including a password group storage unit and an unlabeled key group storage unit, and the password group storage unit and the unlabeled key group storage unit being connected to the online receiver module, and the storage device being connected to the connection module of each target device through the online receiver module.

2. The system for maintaining the confidentiality of data and storing and transmitting the data as claimed in claim 1, wherein the connection module is a cable or wireless connection device.

3. A method for maintaining the confidentiality of data, and storing and transmitting the data, comprising:
using a first encryption unit to form a key by encrypting a random value by an encryption program unit of an encryption/decryption module of a target device;
using a second encryption unit to generate a password from data of the target device and the key;
linking the key and the password with an online receiver module of a storage device by the connection module;
storing the key into an unlabeled key group storage unit after the online receiver module has received the key and the password;
storing the password into a password group storage unit;
using a key identification unit for a key comparison by a decryption program unit of the encryption/decryption module of the target device; and
eliminating all labeled keys to obtain unlabeled keys, and then using the decryption unit to compare with the password obtained by the storage device;
such that if the comparison fails, then another key will be decrypted, and if the comparison succeeds, then the data and the key will be obtained, and the obtained key will be stored with label or without label.
